(19) United States
(12) Patent Application Publication
(10) Pub. No.: US 2022/0268900 A1
(43) Pub. Date: Aug. 25, 2022

(54) RANGING SYSTEM

(71) Applicant: Sony Semiconductor Solutions Corporation, Kanagawa (JP)

(72) Inventor: Takashi Masuda, Tokyo (JP)

(21) Appl. No.: 17/629,005

(22) PCT Filed: Sep. 17, 2020
(86) PCT No.: PCT/JP2020/035273

§ 371 Date: Jan. 21, 2022

Related U.S. Application Data
(60) Provisional application No. 62/904,356, filed on Sep. 23, 2019.

(51) Int. Cl. G01S 7/4865; G01S 7/4861; G01S 17/10

(52) U.S. Cl. CPC G01S 7/4865; G01S 7/4861; G01S 17/10

(57) ABSTRACT

Ranging systems with increased accuracy without increased mounting area are disclosed. In one example, a ranging system includes a drive unit, a sensor, a measurement unit and a ranging observation unit. The drive unit outputs a drive signal to cause a light emitting element to emit light to irradiate an object according to a trigger signal. The detects reflection light from the object. The measurement unit measures a delay time between the trigger signal and a timing at which the light emitting element actually emits light. The ranging observation unit calculates the distance to the object based on the timing of the trigger signal, a light receiving timing of the reflection light, and the delay time. The measurement unit charges a capacitor during a period between the trigger signal and the drive signal, and acquires the delay time according to a charging voltage of the capacitor.

### FIELD

The present disclosure relates to a ranging system.

### BACKGROUND

When a distance to an object is determined based on a time of flight (TOF) method by receiving reflection light obtained when radiation light radiated from a light emitting part is reflected by the object and returns, and using an output corresponding to the amount of light received, it is necessary to accurately measure the time from light emission to light receiving. In the TDC (time-to-digital conversion circuit) of Patent Literature 1, a clocked value is obtained by connecting a plurality of stages of NOT gates with each other, taking an output of each stage into a flip-flop, and decoding an output of the flip-flop.

### CITATION LIST

### Patent Literature

Patent Literature 1: JP 2013-195306 A

### SUMMARY

### Technical Problem

In Patent Literature 1, in order to realize high resolution and high range clocking for more accurate ranging, it is necessary to provide a large number of NOT gates and flip-flops. However, when a large number of NOT gates and flip-flops are provided, the mounting area of the circuit is increased.

To address this issue, the present disclosure proposes a ranging system capable of measuring a distance more accurately without increasing the mounting area.

### Solution to Problem

The ranging system according to the present disclosure includes: a drive unit that outputs a drive signal for causing a light emitting element to emit light to irradiate an object with light; a sensor that detects reflection light from the object; a measurement unit that measures a delay time included in a time from a timing at which a trigger signal for causing the light emitting element to emit light is output to a timing at which the light emitting element actually emits light; and a processing unit that performs processing of calculating the distance to the object based on an output timing of the trigger signal, a light receiving timing of the reflection light obtained by the sensor, and the delay time, wherein the measurement unit includes a capacitor that is charged by a charging current, a charging unit that charges the capacitor during a period from an input timing of the trigger signal to the output timing of the drive signal, and an analog-to-digital conversion unit that converts a charging voltage of the capacitor into digital data, and the delay time is obtained from digital data to be converted by the analog-to-digital conversion unit.

### BRIEF DESCRIPTION OF DRAWINGS

FIG. 1 is a block diagram illustrating a configuration of an example of a ranging system applicable to each embodiment of the present disclosure.

FIG. 2 is a diagram illustrating an example of a histogram applicable to a ranging system based on a time at which a ranging sensor receives light.

FIG. 3 is a diagram illustrating a more specific configuration of a ranging system including a driver and a signal processor.

FIG. 4 is a diagram illustrating an operation example of the ranging system.

FIG. 5 is a diagram illustrating a configuration example of a time-to-digital conversion circuit according to a first embodiment of the present disclosure.

FIG. 6 is a timing chart illustrating an operation example of the time-to-digital conversion circuit.

FIG. 7 is a diagram illustrating a main part of a ranging system using a time-to-digital conversion circuit according to a second embodiment.

FIG. 8 is a diagram for explaining variations in the charging characteristics of a capacitor.

FIG. 9 is a diagram for explaining first calibration of the time-to-digital conversion circuit.

FIG. 10 is a flowchart for explaining processing of the first calibration.

FIG. 11 is a timing chart illustrating an operation of the ranging system using a time-to-digital conversion circuit that performs first calibration.

FIG. 12 is a timing chart illustrating a charging voltage of a capacitor and a delay time obtained by measurement at the time-to-digital conversion circuit.

FIG. 13 is a diagram illustrating a ranging system using a time-to-digital conversion circuit according to a third embodiment.

FIG. 14 is a timing chart illustrating operation of each part in FIG. 13.

FIG. 15 is a diagram illustrating a ranging system according to a fourth embodiment of the present disclosure.

FIG. 16 is a timing chart illustrating an operation example of the ranging system according to the fourth embodiment.

FIG. 17 is a flowchart illustrating an operation example of the ranging system according to the fourth embodiment.

FIG. 18 is a diagram illustrating a ranging system according to a fifth embodiment of the present disclosure.

FIG. 19 is a flowchart illustrating an operation example of a ranging system according to the fifth embodiment of the present disclosure.

FIG. 20 is a diagram for explaining an example of delay time calculation by the ranging system.

FIG. 21 is a diagram illustrating an example of the rising timing of the main signals of the ranging system according to the fifth embodiment.

FIG. 22 is a diagram illustrating a ranging system according to a sixth embodiment.

FIG. 23 is a diagram illustrating an internal configuration and the like of a pulse width detection circuit.

FIG. 24A is a diagram illustrating a ranging system according to a seventh embodiment.

FIG. 24B is a diagram illustrating a ranging system according to the seventh embodiment.

FIG. 24C is a diagram illustrating a ranging system according to the seventh embodiment.

### DESCRIPTION OF EMBODIMENTS

Hereinafter, embodiments of the present disclosure will be described in detail with reference to the drawings. Note that, in the following embodiments, the same parts are denoted by the same reference numerals so that redundant description can be omitted.

In addition, the present disclosure will be described according to the following item order.

(0. Configuration common to each embodiment)

[0.1 Configuration]

[0.2 Operation]

(1. First embodiment)

[1.1 Configuration]

[1.2 Operation]

[1.3 Effects]

(2. Second embodiment)

[2.1 Configuration]

[2.2 Operation]

[2.3 Effects]

(3. Third embodiment)

[3.1 Configuration]

[3.2 Operation]

[3.3 Effects]

(4. Fourth embodiment)

[4.1 Configuration]

[4.2 Operation]

[4.3 Effects]

(5. Fifth embodiment)

[5.1 Configuration]

[5.2 Operation]

[5.3 Effects]

(6. Sixth embodiment)

[6.1 Configuration]

[6.2 Operation]

[6.3 Effects]

(7. Seventh embodiment)

(8. Summary)

### 0. Configuration Common to Each Embodiment

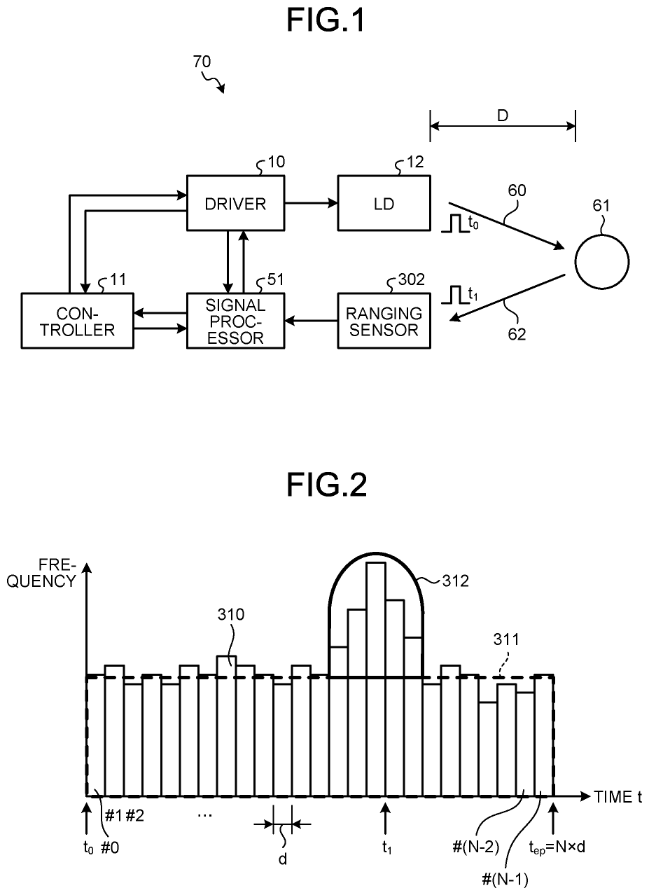

The present disclosure relates to control of a light emitting element that emits light according to a current, such as a laser diode. FIG. 1 is a block diagram illustrating a configuration of an example of a ranging system 70 applicable to each embodiment of the present disclosure. In the following description, it is assumed that the light emitting element is a laser diode (LD). Laser diodes are used in various fields such as ranging, optical transmission, and electrophotographic printers because they can take advantage of characteristics such as excellent light straightness and light condensing property, high response speed, and low power consumption. Note that the light emitting element applicable to the present disclosure is not limited to a laser diode. For example, a light emitting diode (LED) can be applied as the light emitting element.

In FIG. 1, a ranging system 70 as an electronic device includes a driver 10, a laser diode 12, a controller 11, a signal processor 51, and a ranging sensor 302.

The driver 10 drives the laser diode 12 according to a signal of the signal processor 51 to cause the laser diode 12 to emit light. The controller 11 includes, for example, a central processing unit (CPU) and a memory, and supplies a control signal 40 generated by the CPU according to a program stored in the memory in advance to the driver 10 to control the driver 10.

The driver 10 generates a drive signal for driving the laser diode 12 to emit light in a pulse shape in response to the signal supplied from the signal processor 51. This drive signal is input to the laser diode 12. The laser diode 12 emits light in response to a drive signal. That is, the laser diode 12 is caused to emit light based on the drive signal generated by the controller 11. The driver 10 passes a signal indicating a timing at which the laser diode 12 is caused to emit light to the signal processor 51.

The ranging sensor 302 functions as a sensor that detects reflection light from an object. The ranging sensor 302 includes a light receiving element that outputs a light receiving signal by photoelectric conversion based on the received laser light. For the light receiving element, for example, a single photon avalanche diode can be applied. The single photon avalanche diode, also called the SPAD, has a characteristic that electrons generated in response to incidence of one photon generate avalanche multiplication and a large current flows. By using this characteristic of the SPAD, incidence of one photon can be detected with high sensitivity. The light receiving element applicable to the ranging sensor 302 is not limited to the SPAD, and an avalanche photodiode (APD) or a normal photodiode can also be applied.

The signal processor 51 calculates the distance D to an object 61 to be measured based on the time t₀ when the laser light is emitted from the laser diode 12 and the time t₁ when the light is received by the ranging sensor 302.

In the above-described configuration, a laser light 60 emitted from the laser diode 12 at the timing of time t₀, for example, is reflected by the object 61, for example, and is received by the ranging sensor 302 at the timing of time t₁ as reflection light 62. The signal processor 51 determines the distance D to the object 61 based on the difference between the time t₁ at which the reflection light 62 is received by the ranging sensor 302 and the time t₀ at which the laser light is emitted by the laser diode 12. The distance D is calculated by the following equation (1) with the constant c as the light velocity (2.9979×10⁸ [m/sec]).

D=(c/2)×(t₁−t₀) (1)

The signal processor 51 executes the above-described processing repeatedly a plurality of times. The ranging sensor 302 may include a plurality of light receiving elements, and the distance D may be calculated on the basis of each light receiving timing at which the reflection light 62 is received by each light receiving element. The signal processor 51 classifies a time tₘ from the time t₀ of the light emission timing to the light receiving timing at which the light is received by the ranging sensor 302 (referred to as a light receiving time tₘ) on the basis of a class (bins) and generates a histogram.

Note that the light received by the ranging sensor 302 during the light receiving time tₘ is not limited to the reflection light 62 obtained when the light emitted by the laser diode 12 is reflected by the object. For example, ambient light around the ranging sensor 302 is also received by the ranging sensor 302.

FIG. 2 is a diagram illustrating an example of a histogram applicable to a ranging system 70 based on a time at which the ranging sensor 302 receives light. In FIG. 2, the horizontal axis represents a bin, and the vertical axis represents a frequency for each bin. The bins are obtained by classifying the light receiving time tₘ according to each predetermined unit time d. Specifically, bin #0 is 0≤tₘ<d, bin #1 is d≤tₘ<2×d, bin #2 is 2×d≤tₘ<3×d, . . . , and bin #(N−2) is (N−2)×d≤tₘ<(N−1)×d. If the exposure time of the ranging sensor 302 is defined as a time tₑₚ, tₑₚ=N×d. N is a natural number.

The signal processor 51 counts the number of times of acquisitions of the light receiving time tₘ on the basis of the bin, determines the frequency 310 for each bin, and generates a histogram. Here, the ranging sensor 302 also receives light other than the reflection light obtained when the light emitted from the laser diode 12 is reflected. Examples of such light other than the target reflection light include the above-described ambient light. A portion indicated by a range 311 in the histogram includes an ambient light component due to ambient light. The ambient light is light randomly incident on the ranging sensor 302, and is noise for the target reflection light.

On the other hand, the target reflection light is light received according to a specific distance, and appears as the active light component 312 in the histogram. The bin corresponding to the peak frequency in the active light component 312 is the bin corresponding to the distance D of the object 61. The signal processor 51 can calculate the distance D to the object 61 according to the above-described equation (1) by acquiring the representative time of the bin (for example, the time at the center of the bin) as the above-described time t₁. In this manner, by using the plurality of light receiving results, it is possible to perform appropriate ranging despite random noise.

[0.1 Configuration]

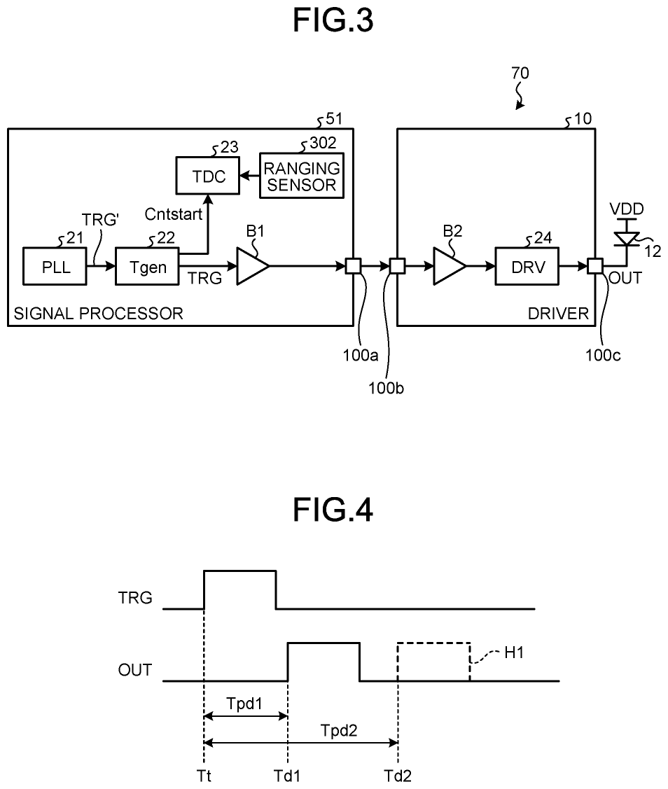

FIG. 3 is a diagram illustrating a more specific configuration of a ranging system 70a including the driver 10 and the signal processor 51 in FIG. 1. In FIG. 3, the ranging system 70a includes the signal processor 51, the driver 10, and the laser diode 12. The signal processor 51 and the driver 10 are connected by coupling parts 100a and 100b. The driver 10 and the laser diode 12 are connected by a coupling part 100c.

The signal processor 51 includes a phase locked loop (PLL) unit 21, a light emission waveform generation unit (Tgen) 22, a time digital converter (TDC) 23, a buffer B1, and a ranging sensor 302. The PLL unit 21 outputs a clock signal serving as a reference of the operation of the ranging system 70. The PLL unit 21 has, for example, a voltage-controlled oscillator that outputs a clock signal, and controls the oscillation frequency of the clock signal based on a phase difference between the clock signal to be output and a reference signal serving as a reference. The light emission waveform generation unit 22 receives the trigger signal TRG′ as an input. The light emission waveform generation unit 22 generates a light emission pattern signal for causing the laser diode 12 to emit light. The light emission waveform generation unit 22 outputs a signal Cntstart for starting clocking simultaneously with the light emission pattern signal.

The TDC 23 outputs a digital signal corresponding to the time from the timing at which the trigger signal TRG is input to the timing at which the ranging sensor 302 detects the reflection light. The TDC 23 has a configuration for performing clocking, and performs clocking from the timing at which the signal Cntstart is input to the timing at which the ranging sensor 302 receives the reflection light.

The buffer B1 has, for example, two complementary metal oxide semiconductor (CMOS) inverters connected in cascade. A differential buffer conforming to the low voltage differential signaling (LVDS) standard may be used. The same applies to the buffer in the following description.

The driver 10 includes a buffer B2 and a drive unit (DRV) 24. The buffer B2 has, for example, two CMOS inverters connected in cascade. The drive unit 24 outputs a drive signal for causing the laser diode 12 to emit light. More specifically, the drive unit 24 generates a drive current for causing the laser diode 12 to emit light, and supplies the generated drive current to the laser diode 12 as an output signal OUT.

The anode terminal of the laser diode 12 is connected to the power supply voltage V_{DD}. The cathode terminal of the laser diode 12 is connected to the coupling part 100c. The anode terminal of the laser diode 12 may be connected to the coupling part 100c, and the cathode terminal of the laser diode 12 may be connected to the ground. In this case, the configuration is such that a drive current flows from the drive unit 24 to the laser diode 12 via the coupling part 100c.

[0.2 Operation]

FIG. 4 is a diagram illustrating an operation example of the ranging system 70a illustrated in FIG. 3. FIG. 4 illustrates the trigger signal TRG and the output signal OUT. As illustrated in FIG. 4, the timing at which the trigger signal TRG rises does not coincide with the timing at which the output signal OUT rises. This is because a signal propagation delay occurs in the driver 10. For example, a time from a time Tt at which the trigger signal TRG rises to a time Td1 at which the output signal OUT rises is defined as a time Tpd1. That is, the delay time of the output signal OUT with respect to the trigger signal TRG is a time Tpd1.

The delay time Tpd1 is not constant due to variations in power supply and temperature environment, and variations between each driver 10. For example, as indicated by a broken line H1 in FIG. 4, if the time at which the output signal OUT rises is delayed from the time Td1 and the output signal OUT rises at the time Td2, the delay time of the output signal OUT with respect to the trigger signal TRG becomes a time Tpd2. That is, in the present example, the delay time in a case where the output signal OUT rises fastest with respect to the trigger signal TRG is the time Tpd1, and the delay time in a case where the output signal OUT rises slowest is the time Tpd2.

In the ranging system 70a, adjustment is necessary to match a desired light emission timing with an actual light emission timing, and there is a possibility that the ranging accuracy is reduced due to a propagation delay that fluctuates due to a change in power supply and temperature environment. In addition, a propagation delay in the signal processor 51 and a propagation delay of the substrate also fluctuate, which may result in a reduction in the ranging accuracy. Therefore, it is necessary to improve the ranging accuracy in consideration of the fluctuation in the propagation delay time depending on the power supply and the temperature environment and the variation between each driver 10.

### 1. First Embodiment

A first embodiment of a time-to-digital conversion circuit (TDC) 23 that functions as a measurement unit in the above-described ranging system 70a will be described.

[1.1 Configuration]

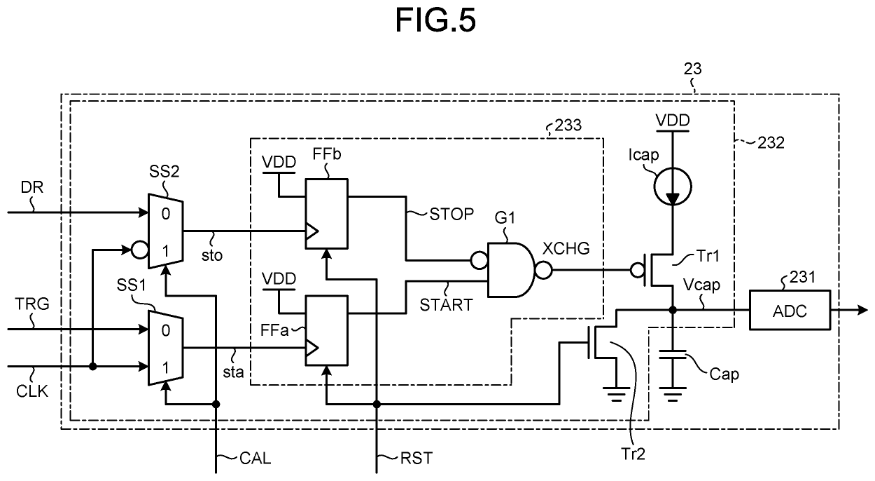

FIG. 5 is a diagram illustrating a configuration example of the TDC 23 according to the first embodiment of the present disclosure. FIG. 5 is a diagram illustrating an exemplary configuration of the TDC 23 suitable for use in the ranging system 70 described with reference to FIG. 3.

The TDC 23 illustrated in FIG. 5 includes a capacitor Cap, an analog-to-digital conversion unit 231, and a charging unit 232.

One end of the capacitor Cap is connected to the charging unit 232. The other end of the capacitor Cap is connected to a reference potential. The reference potential is, for example, ground, but is not limited thereto. The capacitor Cap accumulates charges using a charging current supplied from the charging unit 232. That is, the capacitor Cap is charged by the charging current supplied from the charging unit 232.

The analog-to-digital conversion unit (Analog to Digital Converter; hereinafter sometimes referred to as ADC) 231 outputs a digital value corresponding to an analog voltage value. That is, the ADC 231 converts the analog voltage into digital data. The ADC 231 converts the value of the charging voltage of the capacitor Cap into digital data.

The charging unit 232 has selectors SS1 and SS2, a control unit 233, a current source Icap, and transistors Tr1 and Tr2. The control unit 233 has flip-flops FFa and FFb, and a gate circuit G1. The control unit 233 controls the transistor Tr1 to be turned on or off. Note that, in the present example, the transistor Tr1 is a P-type MOS transistor, and the transistor Tr2 is an N-type MOS transistor.

The selector SS1 and the selector SS2 are each a selector having two inputs and one output. The selector SS1 receives a trigger signal TRG and a clock CLK as an input. The selector SS1 selects the trigger signal TRG when a calibration signal CAL is not input, and selects the clock CLK when the calibration signal CAL is input. The selector SS1 outputs the selected signal as a signal sta. The selector SS2 receives a drive signal DR and an inverted signal of the clock CLK as an input. The selector SS2 selects the drive signal DR when the calibration signal CAL is not input, and selects the inverted signal of the clock CLK when the calibration signal CAL is input. The selector SS2 outputs the selected signal as a signal sto.

The flip-flops FFa and FFb are, for example, D-type flip-flops. The flip-flops FFa and FFb receive an H level from a power supply voltage V_{DD} as an input. The flip-flop FFa holds the H level at the rising timing of the signal sta which is the output of the selector SS1. The flip-flop FFb holds the H level with a signal sto which is the output of the selector SS2.

The transistor Tr1 is turned on or off by an output signal XCHG of the gate circuit G1. When the transistor Tr1 is on, a charging current is supplied to the capacitor Cap. As a result, the capacitor Cap is charged.

The transistor Tr2 is turned on or off by a reset signal RST. The transistor Tr2 is turned on when the reset signal RST is at the H level. When the transistor Tr2 is on, the capacitor Cap is discharged. Discharging the capacitor Cap allows measurement to be performed continuously.

The gate circuit G1 receives a signal START and a signal STOP as inputs, and outputs the output signal XCHG. When the input signal START is input, the gate circuit G1 outputs the output signal XCHG as the L level. When the output signal XCHG is at the L level, the transistor Tr1 is turned on. When the input signal STOP is input, the gate circuit G1 outputs the output signal XCHG as the H level. When the output signal XCHG is at the H level, the transistor Tr1 is turned off.

[1.2 Operation]

The TDC 23 starts charging the capacitor Cap at the input timing, that is, the rising timing of the signal TRG, which is a first signal. The TDC 23 stops charging the capacitor Cap at the input timing of the signal DR, which is a second signal.

When the transistor Tr1 is turned on, a charging current is supplied to the capacitor Cap. This causes the capacitor Cap to be charged. At this time, the transistor Tr2 is off. When the transistor Tr1 is off, the charging current is not supplied to the capacitor Cap, and the capacitor Cap is not charged.

The charging voltage Vcap of the capacitor Cap is converted into digital data by the ADC 231. The larger the charging voltage Vcap of the capacitor Cap is, the larger the value of the digital data converted by the ADC 231 becomes. Accordingly, when the charging current is constant, the charging voltage Vcap has a voltage value proportional to the charging time. Therefore, when the charging voltage Vcap of the capacitor Cap is converted into digital data by the ADC 231, digital data corresponding to the time from the input timing of the first signal to the input timing of the second signal can be obtained.

When the reset signal RST is input, the transistor Tr2 is turned on. When the transistor Tr2 is turned on, the charging voltage Vcap of the capacitor Cap is discharged. At this time, a current of the charges accumulated in the capacitor Cap flows toward the reference potential via the transistor Tr2. When the capacitor Cap is completely discharged, the charging voltage Vcap of the capacitor Cap becomes 0 V. When the transistor Tr2 is off, the charging voltage Vcap of the capacitor Cap is not discharged.

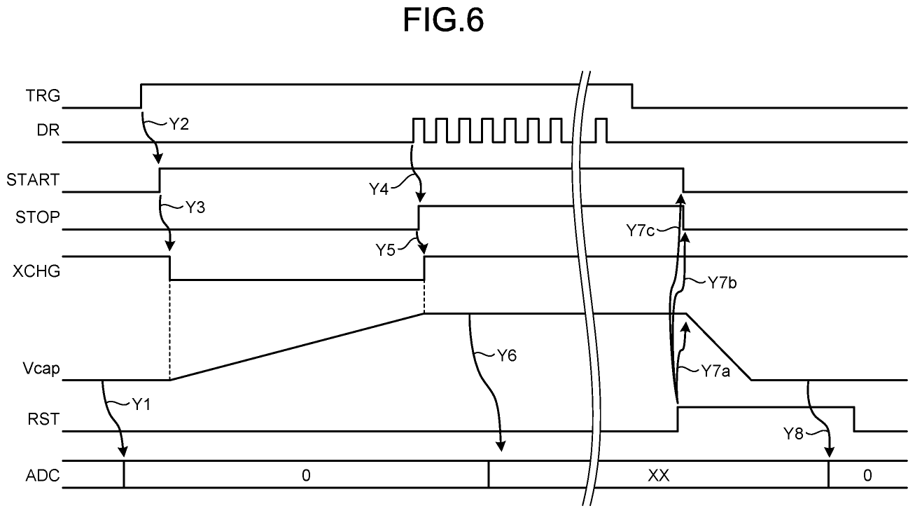

FIG. 6 is a timing chart illustrating an operation example of the TDC 23 illustrated in FIG. 5. FIG. 6 illustrates signals of each unit of the TDC 23 illustrated in FIG. 5. FIG. 6 illustrates the signal TRG, the drive signal DR, the start signal START, the stop signal STOP, the output signal XCHG of the gate circuit G1, the charging voltage Vcap of the capacitor Cap, the reset signal RST, and the content of the digital data output from the ADC 231 (ADC in FIG. 6) in FIG. 5. When the charging voltage Vcap of the capacitor Cap is 0 V, the digital data output from the ADC 231 is “0” (arrow Y1 in FIG. 6).

In FIG. 6, when the signal TRG rises, the flip-flop FFa holds the H level, so that the signal START goes to the H level (arrow Y2 in FIG. 6). Then, the output signal XCHG of the gate circuit G1 goes to the L level (arrow Y3 in FIG. 6), and the transistor Tr1 is turned on. The capacitor Cap is charged within the time during which the transistor Tr1 is on, and the charging voltage Vcap increases.

Thereafter, when the drive signal DR rises, the flip-flop FFb holds the H level, so that the signal STOP goes to the H level (arrow Y4 in FIG. 6). Then, the output signal XCHG of the gate circuit G1 goes to the H level (arrow Y5 in FIG. 6), and the transistor Tr1 is turned off. When the transistor Tr1 is turned on, charging of the capacitor Cap is stopped, and the charging voltage Vcap does not increase. The charging voltage Vcap of the capacitor Cap is converted into digital data by the ADC 231. In this example, the digital data output from the ADC 231 is “XX” (arrow Y6 in FIG. 6).

When the reset signal RST goes to the H level, the transistor Tr2 is turned on, and the charging voltage Vcap of the capacitor Cap is discharged (arrow Y7a in FIG. 6). When the reset signal RST goes to the H level, both the signal START and the signal STOP become the L level (arrows Y7b and Y7c in FIG. 6). When the capacitor Cap is completely discharged, the charging voltage Vcap becomes 0 V, and the digital data output from the ADC 231 returns to “0” (arrow Y8 in FIG. 6).

[1.3 Effects]

Charging the capacitor during a period from the input timing of the trigger signal to the output timing of the drive signal and converting the charging voltage of the capacitor into digital data allows the digital data of the delay time to be obtained.

Furthermore, the TDC 23 described with reference to FIGS. 5 and 6 can be used for the ranging system 70 described with reference to FIG. 3. That is, in FIG. 3, the TDC 23 can perform clocking from the timing at which the start signal Cntstart is input to the timing at which the ranging sensor 302 receives the reflection light.

### 2. Second Embodiment

Next, a ranging system using a time-to-digital conversion circuit according to a second embodiment will be described. In the time-to-digital conversion circuit according to the second embodiment, first calibration is performed.

[2.1 Configuration]

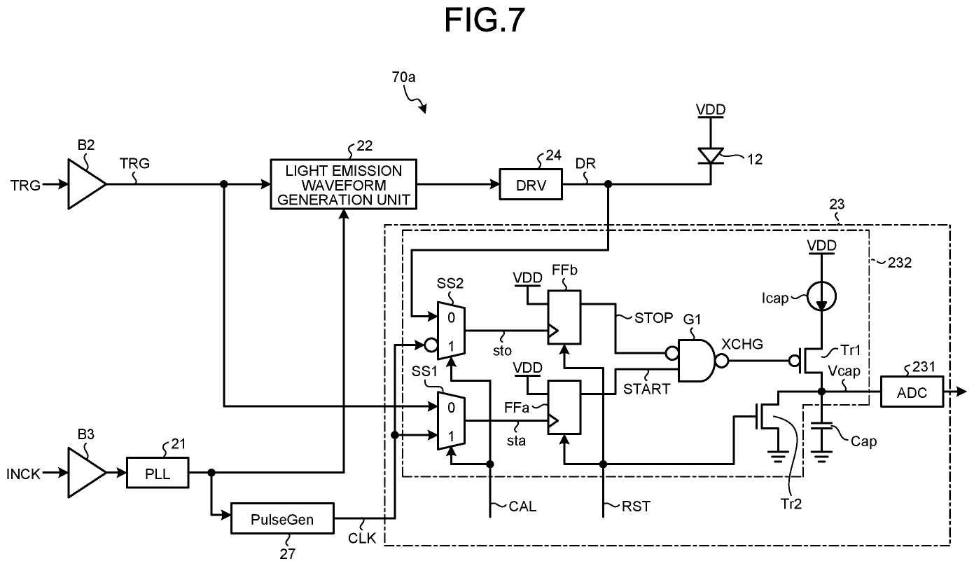

FIG. 7 is a diagram illustrating the main parts of a ranging system 70a using the TDC 23 according to the second embodiment. As illustrated in FIG. 7, the ranging system 70a includes a TDC 23, buffers B2 and B3, a light emission waveform generation unit 22, a drive unit 24, a laser diode 12, a PLL unit 21, and a pulse generation unit (PulseGen) 27. The pulse generation unit 27 generates a clock CLK serving as a reference of the operation of the TDC 23 based on an output of the PLL unit 21.

In FIG. 7, the TDC 23 functions as a measurement unit that measures the time from the rising timing of a trigger signal TRG, which is an input signal to the light emission waveform generation unit 22, to the rising timing of a drive signal DR. That is, the TDC 23 functions as a measurement unit that measures a delay time, which is a time included in the time from the timing at which the trigger signal TRG for causing the laser diode 12 to emit light is output to the timing at which the laser diode 12 actually emits light.

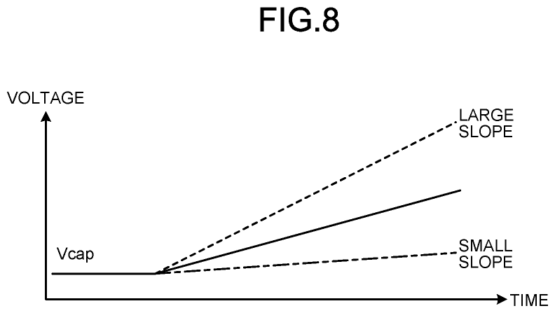

As described with reference to FIGS. 5 and 6, the TDC 23 converts the charging voltage Vcap of a capacitor Cap into digital data to obtain the delay time. When the capacitor Cap is used, the charging characteristics may vary depending on the capacitance value of the capacitor Cap and the charging current of a current source Icap. When this variation is large, the measurement accuracy of the delay time deteriorates, which is not preferable. This will be described with reference to FIG. 8. FIG. 8 is a diagram for explaining variations in the charging characteristics of the capacitor Cap.

As illustrated in FIG. 8, when the charging current of the current source Icap is large and when the capacitance of the capacitor Cap is small, the charging time is shortened, and the slope of the change in the charging voltage Vcap is relatively large. On the other hand, when the charging current of the current source Icap is small and when the capacitance of the capacitor Cap is large, the charging time is prolonged, and the slope of the change in the charging voltage Vcap is relatively small. In this manner, the charging characteristics vary depending on the magnitude of the charging current of the current source Icap and the magnitude of the capacitance of the capacitor Cap. To eliminate the influence of this variation, in the TDC 23, calibration is performed so that the measurement accuracy of the delay time does not decrease.

[2.2 Operation]

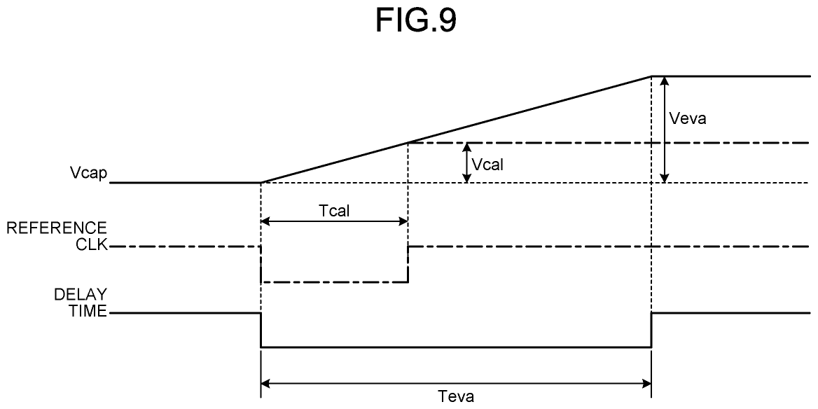

The principle of calibration of the TDC 23 will be described with reference to FIG. 9. FIG. 9 is a diagram for explaining the first calibration of the TDC 23. FIG. 9 illustrates the charging voltage Vcap of the capacitor Cap, a reference clock CLK, and the delay time corresponding to the charging time of the capacitor Cap. The time during which the reference clock CLK is at the L level is a known time Tcal (first time) generated by the PLL unit 21. When the voltage value of the charging voltage Vcap with respect to the known time Tcal is found, the slope of the charging characteristics of the capacitor Cap, that is, Vcal/Tcal can be found. That is, the delay time Teva can be obtained by multiplying the value Veva of the charging voltage when the charging of the capacitor Cap is stopped by the reciprocal of the slope, that is, Tcal/Vcal.

Since the slope of the charging characteristics can be found in advance by performing the first calibration as described above, the delay time Teva with high accuracy can be obtained even if the charging characteristics vary depending on the magnitude of the charging current of the current source Icap and the magnitude of the capacitance of the capacitor Cap.

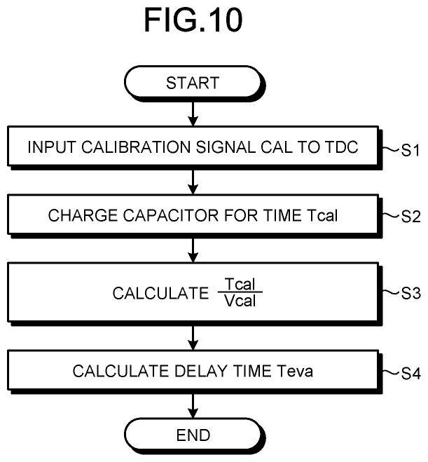

By performing the above-described first calibration before measurement or at every predetermined time, measurement accuracy of the delay time can be maintained. This processing will be further described with reference to FIG. 10. FIG. 10 is a flowchart for explaining the first calibration process.

A calibration signal CAL is input to the TDC 23 (step S1). When the calibration signal CAL is input, the selectors SS1 and SS2 of the TDC 23 select the reference clock CLK, so that the transistor Tr1 is turned on for a time during which the signal XCHG goes to the L level to charge the capacitor Cap (step S2). The capacitor Cap is charged for a time during which the reference clock CLK is at the L level, that is, for a known time Tcal. Since the charging voltage Vcal of the capacitor Cap at a point when the known time Tcal elapses is converted into digital data by the ADC 231, Tcal/Vcal is calculated (step S3). Thereafter, the value of the charging voltage obtained by charging the capacitor Cap from the rising timing of the trigger signal TRG to the rising timing of the drive signal DR is multiplied by Tcal/Vcal to obtain the delay time Teva (step S4).

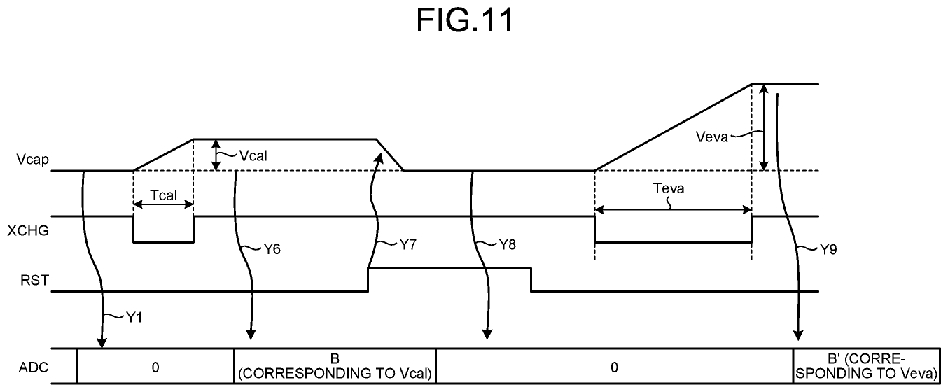

Next, the timing of the operation including the operation of the ADC 231 will be described with reference to FIG. 11. FIG. 11 is a timing chart illustrating the operation of the ranging system 70a using the TDC 23 that performs the first calibration. FIG. 11 illustrates the charging voltage Vcap of the capacitor Cap, an output signal XCHG of the gate circuit G1, a reset signal RST, and contents of the digital data output from the ADC 231. When the charging voltage Vcap of the capacitor Cap is 0 V, the digital data output from the ADC 231 is “0” (arrow Y1 in FIG. 11).

In FIG. 11, the selectors SS1 and SS2 select the reference clock CLK to perform the first calibration. During the time Tcal during which the output signal XCHG of the gate circuit G1 is at the L level, the transistor Tr1 is turned on, so that the capacitor Cap is charged and the charging voltage Vcap increases. After the time Tcal elapses, the charging voltage Vcal at the time Tcal is converted into digital data by the ADC 231 (arrow Y6 in FIG. 11). At this time, the digital data output from the ADC 231 is “B” corresponding to the charging voltage Vcal. Using this digital data and the time Tcal, the above-described Tcal/Vcal can be calculated.

When the reset signal RST rises, the capacitor Cap is discharged and the charging voltage Vcap drops (arrow Y7 in FIG. 11). When the charging voltage Vcap of the capacitor Cap becomes 0 V, the digital data output from the ADC 231 becomes “0” (arrow Y8 in FIG. 11). This is the end of the first calibration.

Thereafter, the selectors SS1 and SS2 are switched, and during a period from the rising timing of the trigger signal TRG to the rising timing of the drive signal DR, the transistor Tr1 is turned on while the output signal XCHG of the gate circuit G1 is at the L level, so that the capacitor Cap is charged and the charging voltage Vcap rises. After the time Teva elapses, the charging voltage Veva at the time Teva is converted into digital data by the ADC 231 (arrow Y9 in FIG. 11). At this time, the digital data output from the ADC 231 is “B′” corresponding to the charging voltage Veva. By multiplying the digital data by Tcal/Vcal described above, the time Teva that is the delay time can be calculated.

[2.3 Effects]

By performing the above-described first calibration, it is possible to eliminate the influence of the variation in the charging characteristics of the capacitor Cap and maintain the measurement accuracy of the delay time by the TDC 23. If the cycle of the reference clock CLK is set to a cycle close to an expected value, the influence of variation can be reduced more accurately.

### 3. Third Embodiment

Next, a ranging system using a time-to-digital conversion circuit according to a third embodiment will be described. In the time-to-digital conversion circuit according to the third embodiment, second calibration is performed.

[3.1 Configuration]

As described above, the TDC 23 uses the ADC 231. Thus, the charging voltage value of the capacitor needs to be within the voltage range that can be converted by the ADC 231. In addition, if there is a range in which conversion can be performed more accurately within the voltage range that can be converted by the ADC 231, it is appropriate to use such a voltage range.

If the capacitance of the capacitor is small, the charging voltage value of the capacitor may reach the upper limit of the voltage range that can be converted by the ADC 231. In this case, an accurate delay time cannot be obtained. To solve this, for example, it is conceivable to increase the capacitance of the capacitor to moderate the increase in the charging voltage, or to decrease the charging current to moderate the increase in the charging voltage. However, it is not preferable to increase the capacitance of the capacitor because it increases the mounting area. In addition, reducing the charging current is not preferable because it increases the susceptibility to noise.

Therefore, in the third embodiment, a time such that the charging time cannot be further shortened is set, and this time is defined as a pause time during which charging of the capacitor is paused. Then, the delay time is obtained by adding a time corresponding to the pause time to the time obtained by converting the charging voltage Vcap of the capacitor Cap.

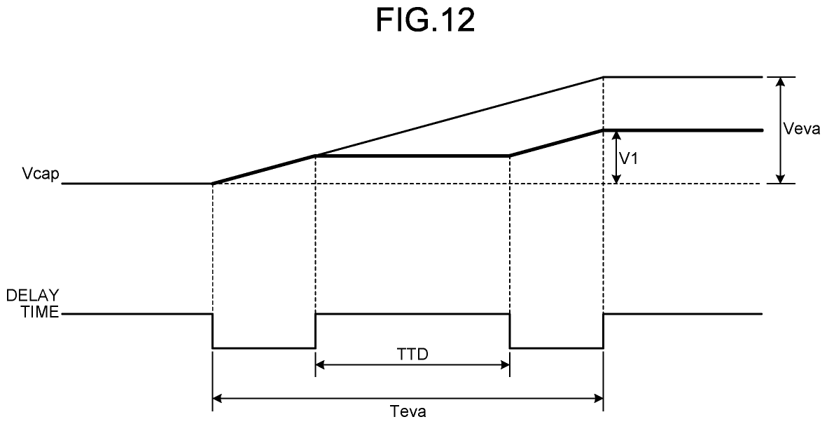

Here, FIG. 12 is a timing chart illustrating the charging voltage Vcap of the capacitor Cap and a delay time obtained by the measurement of the TDC 23. FIG. 12 illustrates the above-described principle.

In FIG. 12, when the charging current is supplied to the capacitor Cap, the charging voltage Vcap increases as described with reference to FIG. 9. This allows the charging voltage value Veva to be obtained. On the other hand, if a pause time TTD (second time), which is a known time, is provided within the charging time, charging is not performed within the pause time TTD. Accordingly, the charging voltage value corresponding to the delay time Teva is a voltage V1 that is lower than the charging voltage value Veva. The delay time Teva can be obtained by adding a time corresponding to the pause time TTD to the time obtained by converting the voltage V1 at the ADC 231.

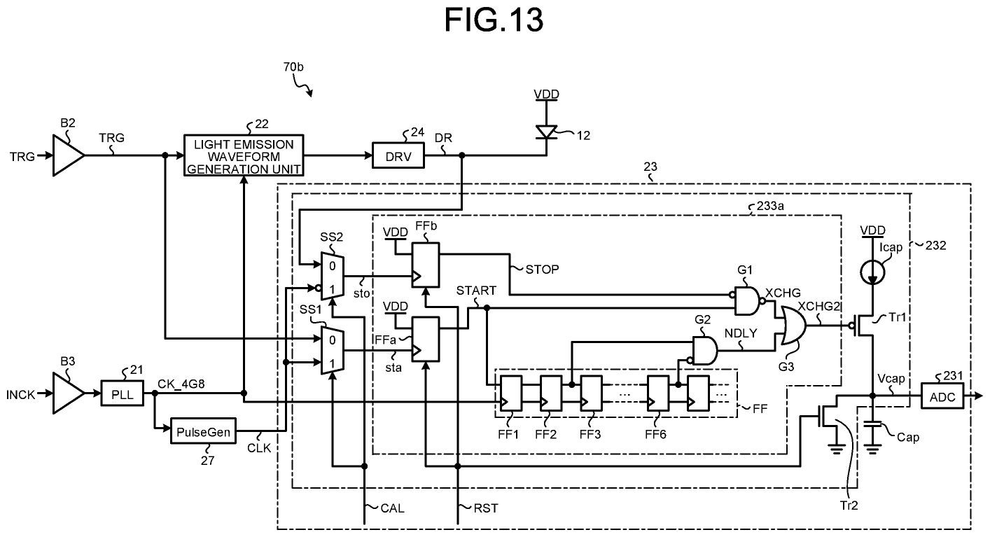

FIG. 13 is a diagram illustrating a ranging system 70b using the time-to-digital conversion circuit according to the third embodiment. In FIG. 13, a ranging system 70b has a configuration in which a control unit 233a is used in the ranging system 70a described with reference to FIG. 7. The control unit 233a has a configuration in which a flip-flop group FF and gate circuits G2 and G3 are added to the control unit 233.

The flip-flop group FF has a plurality of flip-flops FF1, FF2, FF3, and so on. The plurality of flip-flops FF1, FF2, FF3, and so on have a configuration in which, for example, D-type flip-flops are cascade-connected in a plurality of stages. A signal START is input to the flip-flop FF1. In this example, an output signal of the flip-flop FF2 of the second stage and an output signal of the flip-flop FF6 of the sixth stage are taken out and input to the gate circuit G2.

Each of the flip-flops FF1, FF2, FF3, and so on is operated by a clock CK_4G8 having a frequency of 4.8 GHz, for example. For the input data to pass through the flip-flop 1 stage, a time corresponding to the reciprocal of 4.8 GHz is required. In this example, pulses having pulse widths corresponding to four stages of flip-flops from the second to sixth stages are output from the gate circuit G2.

The gate circuit G2 outputs an output signal NDLY based on the output signal of the flip-flop FF2 and a signal obtained by inverting the output signal of the flip-flop FF6. The output signal NDLY is at the H level during a period from the timing at which the output signal of the flip-flop FF2 goes to the H level to the timing at which the output signal of the flip-flop FF6 goes to the H level. The time during which the output signal NDLY goes to the H level is the above-described pause time TTD.

The gate circuit G3 is an OR gate circuit. When the output signal XCHG of the gate circuit G1 is at the L level or the output signal NDLY is at the L level, the gate circuit G3 outputs an output signal XCHG2 as the L level. When the output signal XCHG2 is at the L level, the transistor Tr1 is turned on.

The number of stages of the flip-flops included in the flip-flop group is determined based on an operation clock. When the operation clock is slow, the number of stages of flip-flops can be reduced.

[3.2 Operation]

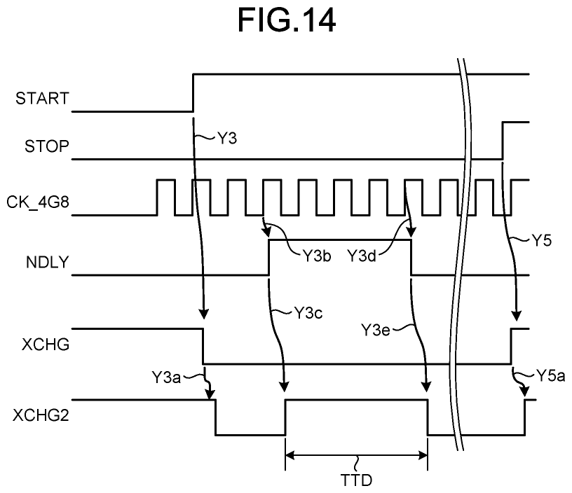

Next, the operation of each unit in FIG. 13 will be described. FIG. 14 is a timing chart illustrating the operation of each unit in FIG. 13. FIG. 14 illustrates the signal START, signal STOP, clock CK_4G8, output signal NDLY, signal XCHG, and signal XCHG2.

In FIG. 14, similarly to FIG. 6, in the TDC 23, the signal XCHG goes to the L level at the rising timing of the signal START (arrow Y3 in FIG. 14), and the signal XCHG2 goes to the L level (arrow Y3a in FIG. 14). This turns on the transistor Tr1 and starts charging of the capacitor Cap.

Thereafter, the output signal NDLY goes from the L level to the H level at the timing at which the output signal of the flip-flop FF2 of the clock CK_4G8 goes to the H level (arrows Y3b and Y3c in FIG. 14), and the signal NDLY goes from the H level to the L level at the timing at which the output signal of the flip-flop FF6 of the clock CK_4G8 goes to the H level (arrows Y3d and Y3e in FIG. 14). During the pause time TTD, which is a time when the output signal NDLY is at the H level, the signal XCHG2 is at the H level and the charging of the capacitor Cap is paused.

At the rising timing of the signal STOP, the signal XCHG goes to the H level (arrow Y5 in FIG. 14), and the signal XCHG2 goes to the H level (arrow Y5a in FIG. 14). This turns off the transistor Tr1 and stops charging of the capacitor Cap. The ADC 231 converts the charging voltage value of the capacitor Cap while charging is stopped into digital data. The delay time Teva can be obtained by adding the pause time TTD to the time corresponding to the digital data obtained by the conversion.

[3.3 Effects]

By performing the above-described second calibration, it is possible to maintain the measurement accuracy of the delay time by the TDC 23 without increasing the capacitance of the capacitor Cap. Therefore, the capacitor Cap having a relatively small capacitance can be used, thereby allowing the mounting area of the entire circuit to be limited.

In the pause time TTD, since the transistor Tr1 is turned on and off, there is a concern about the influence of the switching operation on the measurement accuracy. As a configuration for reducing this influence, it is conceivable to input the output signal NDLY corresponding to the pause time TTD to the selectors SS1 and SS2 as a signal CAL.

### 4. Fourth Embodiment

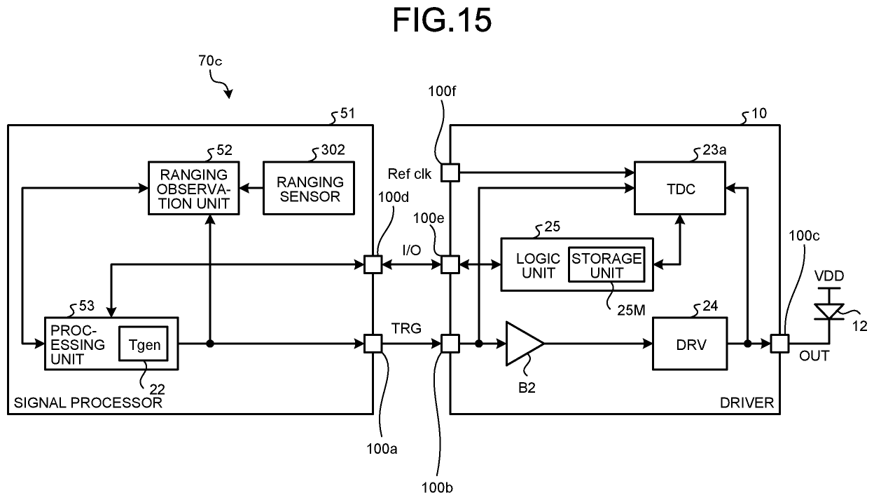

Next, a fourth embodiment of the present disclosure will be described. FIG. 15 is a diagram illustrating a ranging system 70c according to a fourth embodiment of the present disclosure.

[4.1 Configuration]

In FIG. 15, the ranging system 70c includes a signal processor 51, a driver 10, and a laser diode 12. The signal processor 51 and the driver 10 are connected by coupling parts 100a and 100b and coupling parts 100d and 100e.

The signal processor 51 includes a ranging observation unit 52, a processing unit 53, and a ranging sensor 302. The processing unit 53 has a light emission waveform generation unit 22. The light emission waveform generation unit 22, which is a light emission waveform generation unit, outputs a trigger signal TRG. The ranging observation unit 52 calculates the distance D to an object 61 based on the output timing of a trigger signal TRG and the light receiving timing of the reflection light obtained by the ranging sensor 302. The processing unit 53 controls each unit of the signal processor 51. Since the ranging sensor 302 has already been described with reference to FIG. 1, a detailed description thereof will be omitted here.

The driver 10 includes a buffer B2, a TDC 23a, a drive unit 24, a logic unit 25, and a coupling part 100f. The TDC 23a starts clocking in response to the trigger signal TRG, and ends clocking when the drive unit 24 outputs an output signal OUT.

The logic unit 25 has a storage unit 25M. The storage unit 25M stores digital data corresponding to a delay time that is a measurement result by the TDC 23a. The storage unit 25M has, for example, a register. The storage unit 25M may be a memory. A clock signal Refclk serving as a reference of the operation of the TDC 23a is input to the coupling part 100f.

Here, the processing unit 53 of the signal processor 51 is connected to the logic unit 25 of the driver 10 via the coupling parts 100d and 100e. Input/output signals I/O can be transmitted and received between the processing unit 53 and the logic unit 25. Therefore, the processing unit 53 of the signal processor 51 can access the storage unit 25M of the logic unit 25. Therefore, the processing unit 53 can acquire digital data corresponding to the delay time stored in the storage unit 25M of the logic unit 25.

[4.2 Operation]

The light emission waveform generation unit 22 in the processing unit 53 of the signal processor 51 outputs the trigger signal TRG. The trigger signal TRG is input to the driver 10 via the coupling parts 100a and 100b. The TDC 23a in the driver 10 starts clocking when the trigger signal TRG is input thereto. When the drive unit 24 outputs the output signal OUT, the TDC 23a ends clocking. The TDC 23a transmits the digital data corresponding to the delay time obtained by clocking to the logic unit 25. The logic unit 25 stores the digital data corresponding to the delay time acquired from the TDC 23a in the storage unit 25M.

The processing unit 53 of the signal processor 51 accesses the logic unit 25 of the driver 10 via the coupling parts 100d and 100e. The processing unit 53 acquires the digital data of the delay time stored in the storage unit 25M of the logic unit 25. The processing unit 53 transmits the digital data of the delay time acquired from the storage unit 25M to the ranging observation unit 52. The ranging observation unit 52 calculates the distance D to the object 61 using the digital data corresponding to the delay time (hereinafter, may be referred to as ranging). That is, the ranging observation unit 52 performs ranging using the delay time. The ranging observation unit 52 subtracts the digital data corresponding to the delay time acquired from the storage unit 25M from the time from the timing at which the trigger signal TRG is output to the timing at which the ranging sensor 302 receives light. With this configuration, it is possible to know not the trigger signal TRG output timing, but the timing closer to the actual light emission timing, and thus it is possible to remove the delay time due to the internal circuit of the driver 10. As a result, it is possible to obtain an effect of improving the accuracy of the measurement of the distance D.

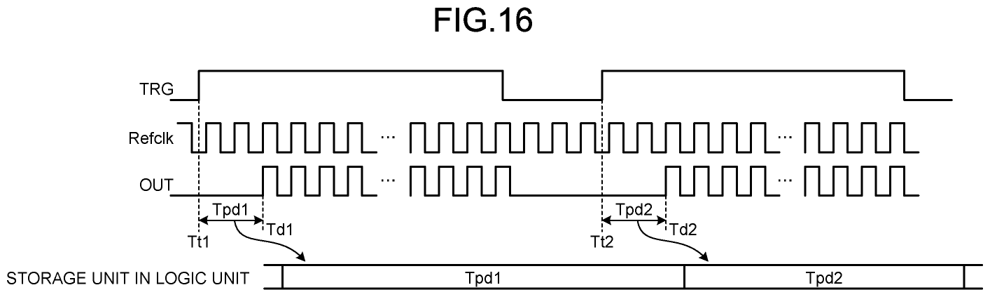

FIG. 16 is a timing chart illustrating an operation example of the ranging system 70c according to the fourth embodiment illustrated in FIG. 15. FIG. 16 illustrates the trigger signal TRG, the clock signal Refclk, the output signal OUT, and the contents stored in the storage unit 25M in the logic unit 25.

In FIG. 16, clocking by the TDC 23a is started at the timing at which the trigger signal TRG changes to the high level, that is, at the rising time Tt1. The TDC 23a charges a capacitor Cap during a period from the rise of the trigger signal TRG to the rise of the signal OUT, and converts the charging voltage into digital data at the ADC 231, thereby obtaining a clocked value. Then, the digital data of the clocked value “Tpd1” from the time Tt1 to the time Td1 at which the output signal OUT rises is transmitted to the logic unit 25. The logic unit 25 stores the digital data of the clocked value in the storage unit 25M.

Similarly, at the timing at which the trigger signal TRG changes to the high level next, that is, at the rising time Tt2, clocking by the TDC 23a is started. The TDC 23a charges a capacitor Cap during a period from the rise of the trigger signal TRG to the rise of the signal OUT, and converts the charging voltage into digital data at the ADC 231, thereby obtaining a clocked value. Then, the digital data of the clocked value “Tpd2” from the time Tt2 to the time Td2 at which the output signal OUT rises is transmitted to the logic unit 25. The logic unit 25 stores the digital data of the clocked value “Tpd2” in the storage unit 25M.

Thereafter, the digital data of the clocked value of the TDC 23a is similarly stored in the storage unit 25M. The digital data of the clocked value stored in the storage unit 25M is a delay time from when the trigger signal TRG is input until the laser diode 12 actually emits light. That is, it is possible to measure the time Tpd1 and the time Tpd2, which are delay times described with reference to FIG. 4, and to store the digital data in the storage unit 25M. With this configuration, it is possible to perform ranging using the digital data stored in the storage unit 25M.

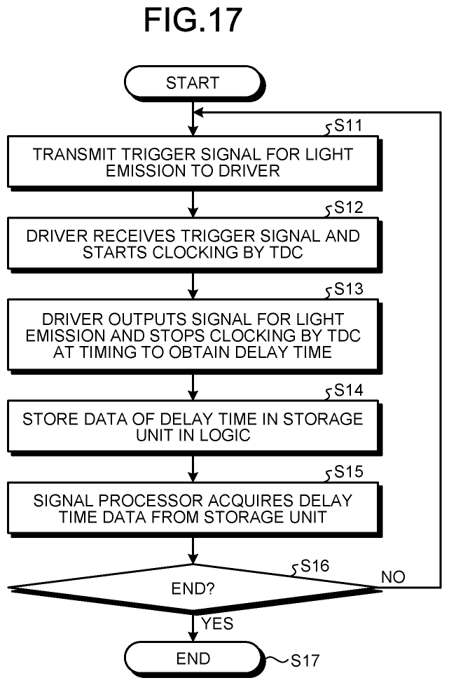

An operation example of the entire ranging system 70c illustrated in FIG. 15 will be described. FIG. 17 is a flowchart illustrating an operation example of the ranging system 70c according to the fourth embodiment illustrated in FIG. 15.

In FIG. 17, the trigger signal TRG for causing the laser diode 12 to emit light is transmitted from the signal processor 51 to the driver 10 (step S11).

The driver 10 receives the trigger signal TRG and starts clocking by the TDC 23a (step S12). The driver 10 outputs a drive signal for causing the laser diode 12 to emit light, stops clocking by the TDC 23a at that timing, and obtains a delay time (step S13). The driver 10 stores digital data corresponding to the delay time in the storage unit 25M in the logic unit 25 (step S14).

The processing unit 53 of the signal processor 51 acquires the digital data corresponding to the delay time from the storage unit 25M in the logic unit 25 (step S15).

Next, it is determined whether or not to end the processing (step S16). When it is determined that the processing is not ended, the processing returns to step S11 to perform the above-described steps (NO in step S16→S11). When it is determined that the processing is ended, the processing ends (YES in step S16→S17).

Note that the above processing described with reference to FIG. 17 may be performed every time the laser diode 12 is caused to emit light, or may be performed not every time but once every time the laser diode 12 is caused to emit light a predetermined number of times. The above processing may be performed at predetermined time intervals. The above processing may be performed only at the time of starting the system, and may not be performed thereafter.

[4.3 Effects]

By using the TDC 23a for the ranging system, the capacitor Cap is charged during a period from the rise of the trigger signal TRG to the rise of the signal OUT, and the charging voltage is converted into digital data by the ADC 231, so that a clocked value can be obtained.

### 5. Fifth Embodiment

Next, a fifth embodiment of the present disclosure will be described. In the above-described fourth embodiment, the delay time is measured in the driver 10. On the other hand, in the fifth embodiment, the signal processor 51 measures the delay time.

[5.1 Configuration]

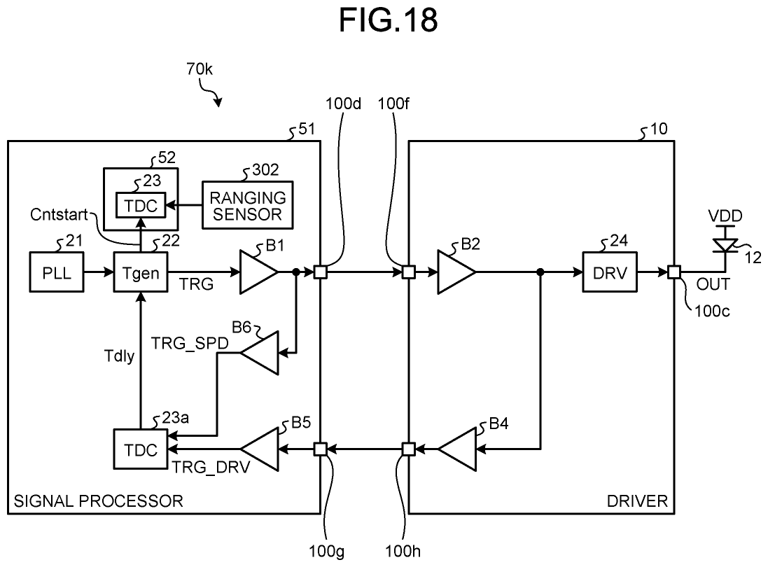

FIG. 18 is a diagram illustrating a ranging system 70k according to a fifth embodiment of the present disclosure. In FIG. 18, a ranging system 70k includes the signal processor 51, a driver 10, and a laser diode 12. The signal processor 51 and the driver 10 are connected by coupling parts 100a and 100b and coupling parts 100g and 100h. The driver 10 and the laser diode 12 are connected by a coupling part 100c.

The signal processor 51 includes a PLL unit 21, a light emission waveform generation unit (Tgen) 22, TDCs 23 and 23a, buffers B1, B5, and B6, and a ranging sensor 302. The light emission waveform generation unit 22 outputs a trigger signal TRG. The trigger signal TRG is a light emission pattern signal for causing the laser diode 12 to emit light. The light emission waveform generation unit 22 outputs the trigger signal TRG and outputs a signal Cntstart. The buffer B5 receives the trigger signal TRG output from the buffer B1 and outputs the trigger signal TRG to the TDC 23a. The buffer B6 receives a signal input from the coupling part 100g and outputs the signal to the TDC 23a. The buffers B5 and B6 have, for example, two CMOS inverters connected in cascade.

The TDC 23a has the same configuration as the TDC 23. The TDC 23a starts clocking when the signal output from the buffer B5 is input. The TDC 23a ends clocking when the signal output from the buffer B6 is input. Although the timing at which the laser diode 12 actually emits light is unknown, here, the time until the timing immediately before the light emission, which is close to the actual light emission timing, is measured as the delay time. That is, the TDC 23a functions as a measurement unit that measures a delay time that is a time included in the time from the timing at which the trigger signal TRG for causing the laser diode 12 to emit light is output to the timing at which the laser diode 12 actually emits light. Other configurations of the signal processor 51 are similar to those of the ranging system 70 described with reference to FIG. 3, and thus description thereof is omitted.

The driver 10 includes buffers B2 and B4 and a drive unit 24. A signal on the input side of the drive unit 24 is branched. The branched signal is a signal derived from the light emission timing, and is input to the buffer B4. The buffer B4 returns the branched signal to the signal processor 51. The buffer B4 receives the signal output from the buffer B2 and outputs the signal to the signal processor 51 via the coupling parts 100g and 100h. Other configurations of the driver 10 are similar to those of the ranging system 70 described with reference to FIG. 3, and thus description thereof is omitted.

[5.2 Operation]

The TDC 23a functioning as the measurement unit branches the transmission path of the trigger signal TRG in the signal processor 51, and starts clocking from the rising timing of the returned signal. Then, the TDC 23a branches the transmission path of the trigger signal TRG on the input side of the drive unit 24, ends clocking at the rising timing of the signal that has returned the trigger signal TRG, and sets the clocked value as the delay time. That is, ranging is performed by outputting the trigger signal TRG for causing the laser diode 12 to emit light, and using the delay time generated by the delay element in the path until the trigger signal TRG actually drives the laser diode 12. That is, a time difference between respective signals returned via different systems is measured as the delay time, so that ranging is performed using the delay time.

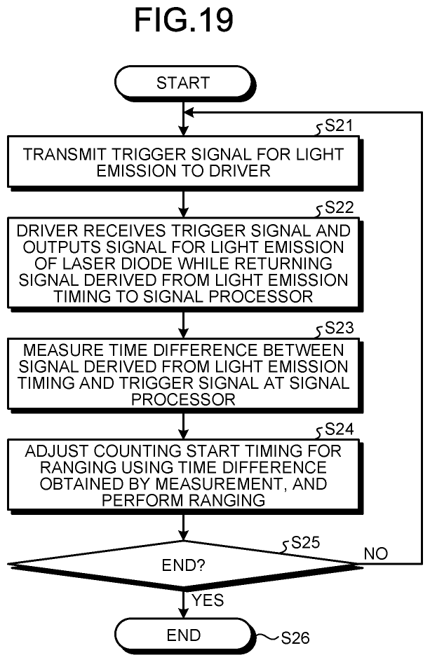

An operation example of the entire ranging system 70k illustrated in FIG. 18 will be described. FIG. 19 is a flowchart illustrating an operation example of the ranging system 70k according to the fifth embodiment of the present disclosure illustrated in FIG. 18.

In FIG. 18, the signal processor 51 transmits the trigger signal TRG for causing the laser diode 12 to emit light to the driver 10 (step S21). The driver 10 receives the trigger signal TRG, outputs a drive signal for causing the laser diode 12 to emit light, and returns the signal derived from the light emission timing to the signal processor 51 (step S22).

The signal processor 51 measures the time difference between the signal derived from the light emission timing and the trigger signal TRG, that is, the delay time (step S23). The signal processor 51 adjusts the clocking start timing for ranging using the time difference obtained by the measurement, that is, the delay time, and performs ranging (step S24).

Specifically, in the TDC 23a, the clocking start timing for ranging is delayed by a time corresponding to the delay time. That is, the TDC 23a starts clocking after the time corresponding to the delay time elapses from the output timing of the trigger signal TRG, and ends clocking at the light receiving timing of the reflection light obtained by the ranging sensor 302. The signal processor 51 calculates the distance to the object 61 based on the clocking result by the TDC 23a. With this configuration, it is possible to perform ranging while adjusting the clocking start timing.

Next, it is determined whether or not to end the processing (step S25). When it is determined that the processing is not ended, the processing returns to step S21 to perform the above-described steps (NO in step S25→S21). When it is determined that the processing is ended, the processing ends (YES in step S25→S26).

The above processing described with reference to FIG. 19 may be performed every time the laser diode 12 is caused to emit light, or may be performed not every time but once every time the laser diode 12 is caused to emit light a predetermined number of times. The above processing may be performed at predetermined time intervals. The above processing may be performed only at the time of starting the system, and may not be performed thereafter.

Similarly to the fourth embodiment illustrated in FIG. 15, a storage unit 25M may be provided, and digital data corresponding to the delay time measured in step S23 may be stored in the storage unit 25M. In this case, the clocking start timing for ranging is adjusted in step S24 using the digital data of the delay time stored in the storage unit 25M.

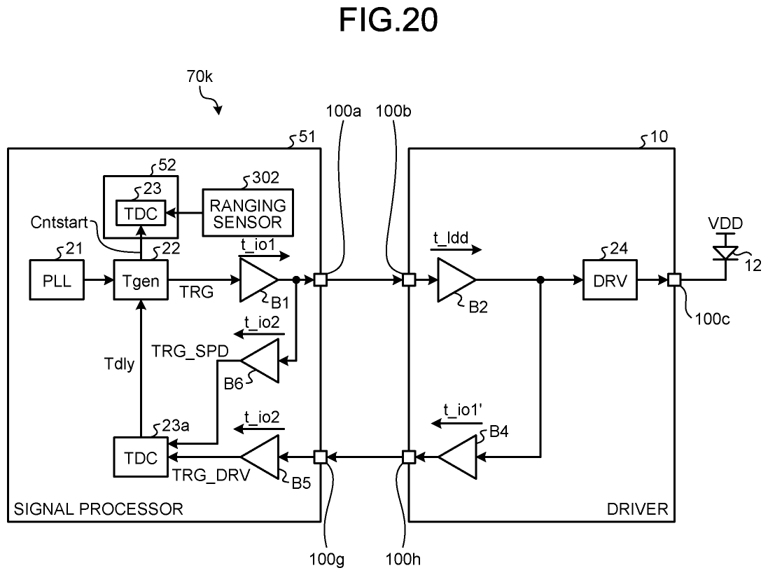

Here, a calculation example of the delay time by the ranging system 70k according to the fifth embodiment illustrated in FIG. 18 will be described. FIG. 20 is a diagram for explaining an example of delay time calculation by the ranging system 70k. In FIG. 20, the delay time at the buffer B1 is defined as t_io1, the delay time at the buffer B2 is defined as t_ldd, the delay time at the buffer B4 is defined as t_io1′, the delay time at the buffer B5 is defined as t_io2, and the delay time at the buffer B6 is defined as t_io2. The delay time at the buffer B5 is equal to the delay time at the buffer B6. Since the buffer B5 and the buffer B6 are formed on the same semiconductor chip, the delay times of the buffer B5 and the buffer B6 can be matched with each other.

A delay time on a path through which the trigger signal TRG is input to the TDC 23a via the buffers B1 and B6 in the signal processor 51 is defined as T1. That is, the difference between the time when the trigger signal TRG is output and the time when a signal TRG_SPD corresponding to the trigger signal TRG is input to the TDC 23a is the delay time T1. The delay time T1 can be expressed by the following equation (2):

T1=t_io1+t_ldd+t_io1′+t_io2 (2)

In addition, a delay time on a path through which the trigger signal TRG travels from the signal processor 51 to the driver 10 and returns to the signal processor 51 via the driver 10 is defined as T2. The difference between the time when the trigger signal TRG is output and the time when a signal TRG_DRV derived from the trigger signal TRG is input to the TDC 23a is the delay time T2. The delay time T2 can be expressed by the following equation (3):

T2=t_io1+t_io2 (3)

Based on the equations (2) and (3), the difference between the delay time T1 and the delay time T2 is expressed by the following equation (4):

T1−T2=t_ldd+t_io1′ (4)

Equation (4) is equal to the delay time Tdly measured by the TDC 23a. The delay time Tdly is input to the light emission waveform generation unit 22 which is a light emission waveform generation unit. The light emission waveform generation unit 22 delays the rising timing of the signal Cntstart by a time corresponding to the delay time Tdly. The delay time Tdly is a difference between the delay time in the signal processor 51 and the delay time in the driver 10, and the accuracy of ranging can be increased by using the delay time Tdly.

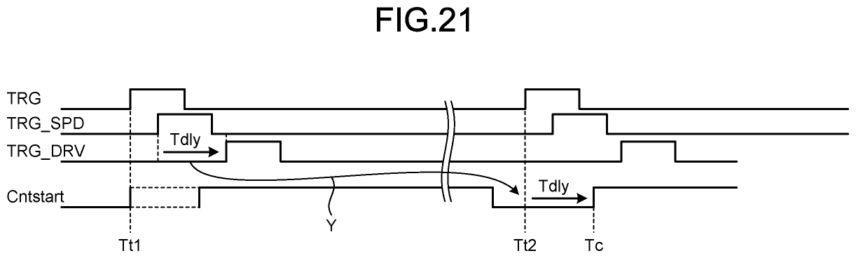

Furthermore, rising timing of main signals of the ranging system 70k illustrated in FIG. 18 will be described. FIG. 21 is a diagram illustrating an example of rising timings of the trigger signal TRG, the signal TRG_SPD corresponding to the trigger signal TRG, the signal TRG_DRV derived from the trigger signal TRG, and the signal Cntstart in FIG. 20.

As illustrated in FIG. 21, the signal TRG_SPD rises with a delay from the rising time Tt1 of the trigger signal TRG, and the signal TRG_DRV rises with a further delay. The time difference between the rising timing of the signal TRG_SPD and the rising timing of the signal TRG_DRV is the above-described delay time Tdly.

The light emission waveform generation unit 22 can use the delay time Tdly to adjust the next or subsequent rising timing of the signal Cntstart. That is, as indicated by an arrow Y in FIG. 21, the signal Cntstart rises at the rising timing Tc that is delayed by the delay time Tdly from the rising time Tt2 of the trigger signal TRG. With this configuration, the clocking start time of the TDC 23a can be matched with or brought closer to the actual light emission timing.

[5.3 Effects]

By using the delay time Tdly that is a difference between the delay time in the signal processor 51 and the delay time in the driver 10, it is possible to match or bring closer the clocking start time of the TDC 23a with or to the actual light emission timing. As a result, it is possible to further increase the accuracy of ranging.

### 6. Sixth Embodiment

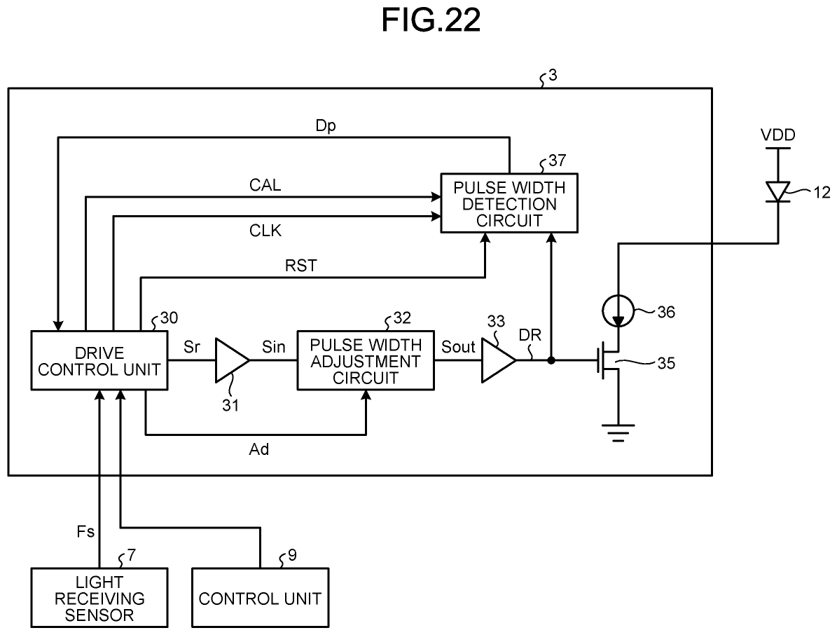

The pulse width can be measured using the above-described TDC. For example, the pulse width of the drive signal DR can be measured. FIG. 22 is a diagram illustrating a ranging system according to a sixth embodiment. FIG. 22 is a diagram illustrating an example of a drive unit 3 that drives a laser diode 12.

[6.1 Configuration]

The drive unit 3 includes a drive control unit 30, a buffer 31, a pulse width adjustment circuit 32, a buffer 33, a drive element 35, a constant current source 36, and a pulse width detection circuit 37. A drive signal DR based on a pulse signal is supplied to the gate of the drive element 35 via the pulse width adjustment circuit 32. During a period in which the drive signal DR is off, the drive element 35 is put into an off state, and the laser diode 12 is put into an off state (non-light emitting state). On the other hand, during the period in which the drive signal DR is on, the drive element 35 is put into an on state, so that a drive current based on a power supply voltage Vs flows through the laser diode 12. That is, the laser diode 12 is put into an on state (light emitting state). At this time, a driving current with a constant current value flows through the laser diode 12 from the constant current source 36.

The drive control unit 30 outputs a reference periodic signal Sr, controls the pulse width adjustment circuit 32, and controls the pulse width detection circuit 37 based on an instruction from a control unit 9. Here, the reference periodic signal Sr is a signal that defines the period of the drive signal DR, and is generated by the drive control unit 30 based on a synchronization signal Fs supplied from a light receiving sensor 7.

The reference periodic signal Sr output from the drive control unit 30 is input to the pulse width adjustment circuit 32 via the buffer 31. Here, the reference periodic signal Sr input from the buffer 31 to the pulse width adjustment circuit 32 is referred to as an “input signal Sin”. The pulse width adjustment circuit 32 generates an output signal Sout having a pulse width corresponding to an adjustment signal Ad output from the drive control unit 30 based on the input signal Sin.

The pulse width detection circuit 37 receives a reference clock CLK, a reset signal RST, and a calibration signal CAL from the drive control unit 30. The pulse width detection circuit 37 detects a pulse width of the drive signal DR and outputs a detection value Dp representing a detection result of the pulse width to the drive control unit 30.

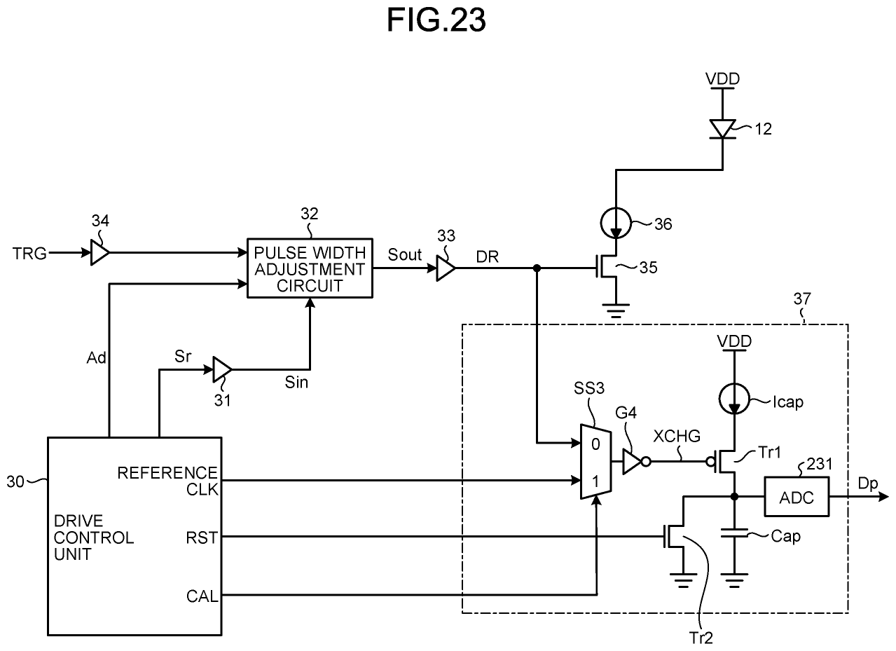

FIG. 23 is a diagram illustrating an internal configuration and the like of the pulse width detection circuit 37 in the drive unit 3 illustrated in FIG. 22. As illustrated in FIG. 23, the pulse width detection circuit 37 has a selector SS3, a gate circuit G4, a current source Icap, transistors Tr1 and Tr2, a capacitor Cap, and an ADC 231. The current source Icap supplies a charging current for charging the capacitor Cap. The transistor Tr1 is provided between the current source Icap and the capacitor Cap. The transistor Tr1 functions as a switch that turns on and off the supply of the charging current to the capacitor Cap. The transistor Tr1 is turned on at the rising timing of the drive signal DR and turned off at the falling timing of the drive signal DR.

The selector SS3 is a selector having two inputs and one output. The selector SS3 outputs the drive signal DR when the calibration signal CAL is not input. The selector SS3 outputs the reference clock CLK when the calibration signal CAL is input. The gate circuit G4 is a NOT gate, inverts the output of the selector SS3, and outputs the inverted output as a signal XCHG.

[6.2 Operation]

In the pulse width detection circuit 37, when the signal XCHG is at the L level, the transistor Tr1 is turned on, and the capacitor Cap is charged. Therefore, when the drive signal DR is at the H level, the capacitor Cap is charged. The capacitor Cap is charged for a time during which the drive signal DR is at the H level, that is, for a time corresponding to the pulse width of the drive signal DR. The charging voltage of the capacitor Cap is converted into digital data by the ADC 231 and output as the detection value Dp.

Here, a rising timing at which the drive signal DR transitions from the L level to the H level is defined as a first signal, and a falling timing at which the drive signal DR subsequently transitions from the H level to the L level is defined as a second signal. According to this definition, it can be said that the pulse width detection circuit 37 has the capacitor Cap charged by the charging current, a charging unit (the transistors Tr1 and Tr2 and the current source Icap) that charges the capacitor Cap during a period from the input timing of the first signal to the input timing of the second signal, and the analog-to-digital conversion unit (ADC 231) that converts the charging voltage of the capacitor Cap into digital data. When the transistor Tr2 is turned on, the capacitor Cap is discharged. That is, the capacitor Cap is discharged after the time corresponding to the pulse width serving as the measurement result is obtained.

Furthermore, in the pulse width detection circuit 37, it is possible to perform the first calibration and the second calibration described above when the calibration signal CAL is input. Therefore, more accurate measurement can be performed while reducing the capacitance of the capacitor to limit the mounting area.

[6.3 Effects]

By charging the capacitor Cap for a time corresponding to the pulse width and converting the charging voltage value into digital data, a time corresponding to the pulse width of the drive signal DR can be obtained, so that the drive control unit 30 can appropriately set the pulse width of the drive signal DR. Since the capacitor Cap is used, it is possible to perform measurement with higher accuracy while limiting the mounting area.

### 7. Seventh Embodiment

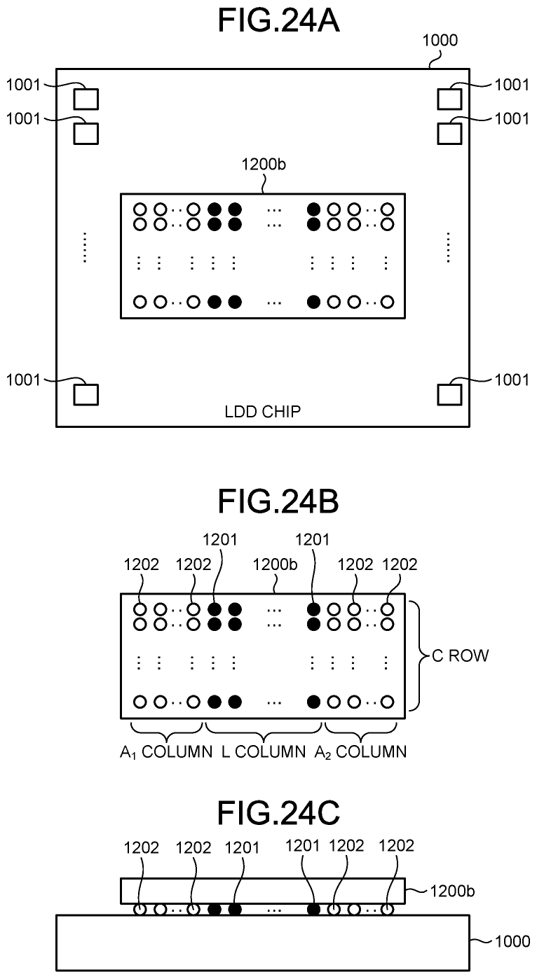

FIGS. 24A to 24C are diagrams illustrating a ranging system according to a seventh embodiment. The seventh embodiment relates to implementation of the laser diode and the driver of the ranging system according to each of the above-described embodiments. In the seventh embodiment, arranged laser diodes (hereinafter, an LD array) and other configurations included in the driver are formed on another substrate.

FIG. 24A is a diagram schematically illustrating a state where an LD array 1200b is arranged on an LDD (laser diode driver) chip 1000 in which each element included in the driver is arranged, which is applicable to each embodiment described above. The LD array 1200b is, for example, Vertical Cavity Surface Emitting Laser (VCSEL). FIG. 24A illustrates a state where the LDD chip 1000 and the LD array 1200b are viewed from a surface (upper surface) on which the light emitting parts of each laser diode 12 included in the LD array 1200b are arranged. Note that, in FIG. 24A and FIG. 24B to be described later, the LD array 1200b is illustrated in a state where the side (back surface) connected to the LDD chip 1000 is seen through from the upper surface side where the light emitting parts of the laser diodes 12 are arranged.

The LDD chip 1000 is one semiconductor chip, and is connected to an external circuit by wire bonding to a plurality of pads 1001 arranged in a peripheral portion. For example, a power supply voltage V_{DD} is supplied to the LDD chip 1000 from the outside via a pad 1001.

FIG. 24B is a diagram schematically illustrating a configuration of the LD array 1200b applicable to the seventh embodiment. As illustrated in FIG. 24B, a cathode terminal 1201 of each of the plurality of laser diodes 12 included in the LD array 1200b and an anode terminal 1202 common to the plurality of laser diodes 12 are arranged and aligned on the back surface of the LD array 1200b.

In the example of FIG. 24B, when the horizontal direction in the drawing is defined as a row and the vertical direction is defined as a column, the cathode terminals 1201 are arranged at the center of the LD array 1200b in a lattice arrangement of C rows×L columns. That is, in this example, (C×L) pieces of laser diodes 12 are arranged in the LD array 1200b. The anode terminals 1202 are arranged in a lattice arrangement of C rows×A₁ columns on the left end side and C rows×A₂ columns on the right end side of the LD array 1200b.

FIG. 24C is a side view of the structure including the LDD chip 1000 and the LD array 1200b, which is applicable to the seventh embodiment, as viewed from the lower end side of FIG. 24A. As illustrated, the LDD chip 1000 and the LD array 1200b have a structure in which the LD array 1200b is stacked on the LDD chip 1000. Each cathode terminal 1201 and each anode terminal 1202 are connected to the LDD chip 1000 by, for example, a microbump.

### 8. Summary

The ranging system 70 includes a time-to-digital conversion circuit (TDC) 23 having a capacitor Cap, a charging unit 232, and an analog-to-digital conversion unit (ADC) 231. The time-to-digital conversion circuit 23 functions as a measurement unit. The capacitor Cap is charged by a charging current. The charging unit 232 charges the capacitor Cap during a period from the input timing of a first signal to the input timing of a second signal. The analog-to-digital conversion unit 231 converts the charging voltage of the capacitor Cap into digital data.

With this configuration, since the charging voltage of the capacitor Cap corresponds to the delay time, it is possible to obtain the delay time by converting the charging voltage into digital data, so that the mounting area is not increased and the distance can be measured more accurately.

The first signal is, for example, a drive signal DR for causing the light emitting element to emit light to irradiate an object with light. The second signal is, for example, a trigger signal TRG for causing the light emitting element to emit light. The ranging system 70 includes a drive unit that outputs the drive signal serving as the first signal, and a ranging sensor 302 that detects reflection light from the object. The time-to-digital conversion circuit 23 serving as the measurement unit further has a signal processor 51 that performs the processing of measuring a delay time, which is a time included in the time from the timing at which the trigger signal serving as the second signal is output to the timing at which the laser diode (LD) 21 that is a light emitting element actually emits light, and calculating the distance to the object 61 based on the output timing of the trigger signal TRG, the light receiving timing of the reflection light obtained by the ranging sensor 302, and the delay time, and obtains the delay time from the digital data converted by the analog-to-digital conversion unit 231.

With this configuration, since the charging voltage of the capacitor Cap corresponds to the delay time, it is possible to obtain the delay time by converting the charging voltage into digital data, so that the mounting area is not increased and the distance can be measured more accurately.

The charging unit 232 has a current source Icap, a transistor Tr1 that functions as a switch, and a control unit 233 that controls the transistor Tr1. The current source Icap supplies a charging current for charging the capacitor Cap to the capacitor Cap. The transistor Tr1 turns on and off the supply of the charging current to the capacitor Cap. The control unit controls the transistor Tr1 based on the trigger signal TRG and the drive signal DR.

With this configuration, it is possible to turn on and off the transistor Tr1 to control the supply of the charging current to the capacitor Cap, so that the mounting area is not increased and the distance can be measured more accurately.

The transistor Tr1 functioning as a switch is provided between the current source Icap and the capacitor Cap, and the control unit turns on the transistor Tr1 at the input timing of the trigger signal TRG and turns off the transistor Tr1 at the input timing of the drive signal DR.

With this configuration, it is possible to turn on and off the transistor Tr1 to control the supply of the charging current to the capacitor Cap, so that the mounting area is not increased and the distance can be measured more accurately.

The control unit 233 has a first flip-flop FFa, a second flip-flop FFb, and a gate circuit G1. The first flip-flop FFa holds the trigger signal TRG. The second flip-flop FFb holds the drive signal DR. The gate circuit G1 receives an output of the first flip-flop FFa and an output of the second flip-flop FFb as inputs. The transistor TR1 is turned on or off depending on an output of the gate circuit G1.

With this configuration, it is possible to turn on and off the transistor Tr1 to control the supply of the charging current to the capacitor Cap, so that the mounting area is not increased and the distance can be measured more accurately.

The ranging system 70 may be configured to supply the charging current to the capacitor Cap for a first time that is a known time, calculate the charging characteristics of the capacitor Cap from the relationship between the first time and the voltage charged in the capacitor Cap by the charging current supplied for the first time, and obtain the delay time based on the calculated charging characteristics and the digital data converted by the ADC 231.

With this configuration, it is possible to measure the distance more accurately even if the charging characteristics of the capacitor Cap have a variation.

Within the time during which the charging current is supplied to the capacitor Cap, the supply of the charging current to the capacitor Cap may be paused for a second time that is a known time, so that the delay time can be obtained by adding the second time to the time corresponding to the digital data converted by the ADC 231.

With this configuration, it is possible to perform more accurate measurement and reduce the capacitance of the capacitor, thus limiting the mounting area.

It is preferable to discharge the voltage charged in the capacitor Cap after obtaining the delay time.

With this configuration, the measurement can be continuously performed.

The ranging system 70c may include a storage unit 25M that stores data corresponding to the delay time, so that the signal processor 51 performs the processing of calculating the distance to the object 61 using data stored in the storage unit 25M.

With this configuration, it is possible to perform ranging using the digital data stored in the storage unit 25M.

The signal processor 51 may start clocking by the TDC 23 after a time corresponding to the delay time elapses from the output timing of the trigger signal TRG and end clocking at the light receiving timing of reflection light, so that the distance to the object 61 is calculated based on the clocking result.

With this configuration, the distance can be measured more accurately.

A pulse width detection circuit 37 serving as the charging unit may be configured to charge the capacitor Cap with the charging current from the rising timing of the pulse that is a first signal to the falling timing of the pulse that is a second signal, and obtain the time corresponding to the pulse width of the drive signal DR based on digital data converted by the analog-to-digital conversion unit 231.

With this configuration, since the charging voltage of the capacitor Cap corresponds to the delay time, it is possible to obtain the time corresponding to the pulse width by converting the charging voltage into digital data, so that the mounting area is not increased and the distance can be measured more accurately.

The pulse width detection circuit 37 serving as the charging unit has a current source Icap, a transistor Tr1 functioning as a switch, and a control unit 233 that controls the transistor Tr1. The current source Icap supplies a charging current for charging the capacitor Cap to the capacitor Cap. The transistor Tr1 turns on and off the supply of the charging current to the capacitor Cap. The control unit controls the transistor Tr1 based on the trigger signal TRG and the drive signal DR.

With this configuration, it is possible to turn on and off the transistor Tr1 to control the supply of the charging current to the capacitor Cap, so that the mounting area is not increased and the distance can be measured more accurately.

The transistor Tr1 functioning as a switch is provided between the current source Icap and the capacitor Cap, and the control unit turns on the transistor Tr1 at the input timing of the trigger signal TRG and turns off the transistor Tr1 at the input timing of the drive signal DR.

With this configuration, it is possible to turn on and off the transistor Tr1 to control the supply of the charging current to the capacitor Cap, so that the mounting area is not increased and the distance can be measured more accurately.

It is preferable to discharge the voltage charged in the capacitor Cap after obtaining the time corresponding to the pulse width.

With this configuration, the measurement can be continuously performed.

Note that the effects described herein are merely examples and are not subject to limitations, and other effects may be provided. In addition, the configurations described herein may be combined as appropriate.

The present technique may also have the following configurations:

(1)

A ranging system comprising a measurement unit including a capacitor that is charged by a charging current, a charging unit that charges the capacitor during a period from an input timing of a first signal to an input timing of a second signal, and an analog-to-digital conversion unit that converts a charging voltage of the capacitor into digital data.

(2)

The ranging system according to (1), wherein

the first signal is a drive signal for causing a light emitting element to emit light to irradiate an object with light,

the second signal is a trigger signal for causing the light emitting element to emit light,

the ranging system comprises:

a drive unit that outputs the drive signal that is the first signal; and

a sensor that detects reflection light from the object,

the measurement unit further includes a processing unit that performs processing of

measuring a delay time that is a time included in a time from a timing at which the trigger signal that is the second signal is output to a timing at which the light emitting element actually emits light, and

calculating a distance to the object based on an output timing of the trigger signal, a light receiving timing of the reflection light obtained by the sensor, and the delay time, and

the delay time is obtained from digital data to be converted by the analog-to-digital conversion unit.

(3)

The ranging system according to (2), wherein

the charging unit includes

a current source that supplies the charging current for charging the capacitor,

a switch that turns on and off the supply of the charging current to the capacitor, and

a control unit that controls the switch based on the trigger signal and the drive signal.

(4)

The ranging system according to (3), wherein

the switch is a transistor provided between the current source and the capacitor, and

the control unit

turns on the transistor at an input timing of the trigger signal and turns off the transistor at an input timing of the drive signal.

(5)

The ranging system according to (4), wherein

the control unit includes

a first flip-flop that holds the trigger signal,

a second flip-flop that holds the drive signal, and

a gate circuit that receives an output of the first flip-flop and an output of the second flip-flop as inputs, and

the transistor is turned on or off by an output of the gate circuit.

(6)

The ranging system according to any one of (2) to (5), wherein

the charging current is supplied to the capacitor for a first time that is a known time, and charging characteristics of the capacitor are calculated from a relationship between the first time and a voltage charged in the capacitor by the charging current supplied for the first time, and

the delay time is obtained based on the calculated charging characteristics and the digital data.

(7)

The ranging system according to any one of (2) to (6), wherein

the supply of the charging current to the capacitor is paused for a second time that is a known time within a time during which the charging current is supplied to the capacitor, and

the second time is added to a time corresponding to digital data converted by the analog-to-digital conversion unit to obtain the delay time.

(8)

The ranging system according to any one of (2) to (7), wherein the voltage charged in the capacitor is discharged after the delay time is obtained.

(9)

The ranging system according to any one of (2) to (8), further comprising

a storage unit that stores data corresponding to the delay time, wherein

the processing unit performs the processing of calculating the distance to the object using the data stored in the storage unit.

(10)

The ranging system according to any one of (2) to (9), wherein

the processing unit

starts clocking after a time corresponding to the delay time elapses from the output timing of the trigger signal, ends clocking at the light receiving timing of the reflection light, and calculates the distance to the object based on the clocking result.

(11)

The ranging system according to (1), wherein

the charging unit charges the capacitor with the charging current during a period from a rising timing of a pulse that is the first signal to a falling timing of a pulse that is the second signal, and

a time corresponding to a pulse width of the pulse is obtained from digital data converted by the analog-to-digital conversion unit.

(12)

The ranging system according to (11), wherein

the charging unit includes

a current source that supplies the charging current for charging the capacitor,

a switch that turns on and off the supply of the charging current to the capacitor, and

a control unit that controls the switch based on the rising timing of the pulse and the falling timing of the pulse.

(13)

The ranging system according to (12), wherein

the switch is a transistor provided between the current source and the capacitor, and

the control unit

turns on the transistor at the rising timing of the pulse and turns off the transistor at the falling timing of the pulse.

(14)

The ranging system according to any one of (11) to (13), wherein the voltage charged in the capacitor is discharged after a time corresponding to the pulse width is obtained.

(15)

A time-to-digital conversion circuit including: a capacitor that is charged by a charging current; a charging unit that charges the capacitor during a period from an input timing of a first signal to an input timing of a second signal; and an analog-to-digital conversion unit that converts a charging voltage of the capacitor into digital data.

(16)

The time-to-digital conversion circuit according to (15), in which

the charging unit includes

a current source that supplies the charging current for charging the capacitor,

a switch that turns on and off the supply of the charging current to the capacitor, and

a control unit that controls the switch based on the first signal and the second signal.

(17)

The time-to-digital conversion circuit according to (16), in which

the switch is a transistor provided between the current source and the capacitor, and

the control unit

turns on the transistor at the input timing of the first signal, and turns off the transistor at the input timing of the second signal.

### REFERENCE SIGNS LIST

7 LIGHT RECEIVING SENSOR

9, 233, 233a CONTROL UNIT

10 DRIVER

11 CONTROLLER

12 LASER DIODE

22 LIGHT EMISSION WAVEFORM GENERATION UNIT

24 DRIVE UNIT

25 LOGIC UNIT

25M STORAGE UNIT

27 PULSE GENERATION UNIT

30 DRIVE CONTROL UNIT

31, 33, B1 to B6 BUFFER

32 PULSE WIDTH ADJUSTMENT CIRCUIT

37 PULSE WIDTH DETECTION CIRCUIT

51 SIGNAL PROCESSOR

52 RANGING OBSERVATION UNIT

53 PROCESSING UNIT

61 OBJECT

70, 70a, 70b, 70c, 70k RANGING SYSTEM

231 ANALOG-TO-DIGITAL CONVERSION UNIT (ADC)

232 CHARGING UNIT

FF FLIP-FLOP GROUP

FFa, FFb FLIP-FLOP

G1, G2, G3, G4 GATE CIRCUIT

SS1, SS2, SS3 SELECTOR

Tr1, Tr2 TRANSISTOR

1. A ranging system comprising a measurement unit including a capacitor that is charged by a charging current, a charging unit that charges the capacitor during a period from an input timing of a first signal to an input timing of a second signal, and an analog-to-digital conversion unit that converts a charging voltage of the capacitor into digital data.

2. The ranging system according to claim 1, wherein
the first signal is a drive signal for causing a light emitting element to emit light to irradiate an object with light,
the second signal is a trigger signal for causing the light emitting element to emit light,
the ranging system comprises:
a drive unit that outputs the drive signal that is the first signal; and
a sensor that detects reflection light from the object,
the measurement unit further includes a processing unit that performs processing of
measuring a delay time that is a time included in a time from a timing at which the trigger signal that is the second signal is output to a timing at which the light emitting element actually emits light, and
calculating a distance to the object based on an output timing of the trigger signal, a light receiving timing of the reflection light obtained by the sensor, and the delay time, and
the delay time is obtained from digital data to be converted by the analog-to-digital conversion unit.

3. The ranging system according to claim 2, wherein
the charging unit includes
a current source that supplies the charging current for charging the capacitor,
a switch that turns on and off the supply of the charging current to the capacitor, and
a control unit that controls the switch based on the trigger signal and the drive signal.

4. The ranging system according to claim 3, wherein
the switch is a transistor provided between the current source and the capacitor, and
the control unit
turns on the transistor at an input timing of the trigger signal and turns off the transistor at an input timing of the drive signal.

5. The ranging system according to claim 4, wherein
the control unit includes
a first flip-flop that holds the trigger signal,
a second flip-flop that holds the drive signal, and
a gate circuit that receives an output of the first flip-flop and an output of the second flip-flop as inputs, and
the transistor is turned on or off by an output of the gate circuit.

6. The ranging system according to claim 2, wherein
the charging current is supplied to the capacitor for a first time that is a known time, and charging characteristics of the capacitor are calculated from a relationship between the first time and a voltage charged in the capacitor by the charging current supplied for the first time, and
the delay time is obtained based on the calculated charging characteristics and the digital data.

7. The ranging system according to claim 2, wherein
the supply of the charging current to the capacitor is paused for a second time that is a known time within a time during which the charging current is supplied to the capacitor, and
the second time is added to a time corresponding to digital data converted by the analog-to-digital conversion unit to obtain the delay time.

8. The ranging system according to claim 2, wherein the voltage charged in the capacitor is discharged after the delay time is obtained.

9. The ranging system according to claim 2, further comprising
a storage unit that stores data corresponding to the delay time, wherein
the processing unit performs the processing of calculating the distance to the object using the data stored in the storage unit.

10. The ranging system according to claim 2, wherein
the processing unit
starts clocking after a time corresponding to the delay time elapses from the output timing of the trigger signal, ends clocking at the light receiving timing of the reflection light, and calculates the distance to the object based on the clocking result.

11. The ranging system according to claim 1, wherein
the charging unit charges the capacitor with the charging current during a period from a rising timing of a pulse that is the first signal to a falling timing of a pulse that is the second signal, and
a time corresponding to a pulse width of the pulse is obtained from digital data converted by the analog-to-digital conversion unit.

12. The ranging system according to claim 11, wherein
the charging unit includes
a current source that supplies the charging current for charging the capacitor,
a switch that turns on and off the supply of the charging current to the capacitor, and
a control unit that controls the switch based on the rising timing of the pulse and the falling timing of the pulse.

13. The ranging system according to claim 12, wherein
the switch is a transistor provided between the current source and the capacitor, and
the control unit
turns on the transistor at the rising timing of the pulse and turns off the transistor at the falling timing of the pulse.

14. The ranging system according to claim 11, wherein the voltage charged in the capacitor is discharged after a time corresponding to the pulse width is obtained.
